(19) United States
(12) Patent Application Publication
(10) Pub. No.: US 2021/0394284 A1
(43) Pub. Date: Dec. 23, 2021

(54) END MILL AND METHOD OF MANUFACTURING END MILL

(71) Applicant: MITSUBISHI HEAVY INDUSTRIES, LTD., Tokyo (JP)

(72) Inventors: Jun ETO, Tokyo (JP); Hirokazu UNNO, Tokyo (JP); Toshiyuki TANAKA, Tokyo (JP)

(21) Appl. No.: 17/288,729

(22) PCT Filed: Jan. 8, 2020
(86) PCT No.: PCT/JP2020/000275

§ 371 Date: Apr. 26, 2021

(30) Foreign Application Priority Data
Feb. 22, 2019 (JP) 2019-030834

(51) Int. Cl. B23C 5/10; B23C 3/16

(52) U.S. Cl. CPC B23C 5/10; B23C 3/16

(57) ABSTRACT

The purpose of the present invention is to precisely process a surface-shaped portion having a fillet. An end mill includes a bottom blade having a protruding curved surface and formed in an arc shape, and a radius blade provided in a corner portion and formed in an arc shape, wherein the radius of the arc portion of the radius blade matches the radius of the arc portion of a fillet-shaped portion of a shape to be processed, and the radius of the arc portion of the bottom blade is equal to or smaller than the minimum radius of the arc portion of a surface-shaped portion adjacent to the fillet-shaped portion.

### TECHNICAL FIELD

The present disclosure relates to an end mill and a method for producing an end mill.

### BACKGROUND ART

When a plate-like aircraft structural component such as the skin or the like of a fuselage or a main wing is produced, a compound curved surface may be formed in a plate-like component (workpiece) by machining. The compound curved surface is generally formed by contouring or streaking using a ball end mill or a radial end mill.

Unlike the ball end mill or the radial end mill, there is a cutting tool called a barrel tool or a lens tool which includes an arc portion having a curved convex shape in an outer peripheral edge or a bottom edge and in which the curvature radius of the arc portion is large. The following PTLs 1 to 3 disclose a tool of which both the outer peripheral edge and the bottom edge have a curvature.

### CITATION LIST

### Patent Literature

[PTL 1] Japanese Patent Publication No. 6278170

[PTL 2] U.S. Pat. No. 6,684,742 Specification

[PTL 3] US Unexamined Patent Application Publication No. 2010/0172703 Specification

### SUMMARY OF INVENTION

### Technical Problem

The lens tool including the arc portion having a curved convex shape in the bottom edge is used when a bottom surface (planar shape) is formed in a workpiece. Accordingly, the feed interval (peak feed) can be made larger than when the ball end mill is used, and a reduction in processing time or an improvement in surface roughness can be obtained.

While the bottom surface and a side surface rising with respect to the bottom surface are formed in the workpiece, in order to improve the strength, a connecting portion between the bottom surface and the side surface may be provided not with a non-rounded pin angle but with a fillet. When the above-described lens tool is used, an uncut portion of the bottom surface and an uncut portion of the side surface are generated depending on the curvature radius of the fillet. For this reason, an error is generated in a processed product formed by machining. In order to remove the generated error, work such as performing additional work such as filing (sanding) to correct a shape is required.

Incidentally, when a processed product having a compound curved surface is formed, it is difficult to incline the end mill due to CAM control and restrictions to a processing device. In that case, it is required to perform machining by tip point control (tool center control).

The present disclosure has been made in view of such circumstances, and an object of the present disclosure is to provide an end mill capable of processing a planar portion having a fillet with high accuracy, and a method for producing an end mill.

### Solution to Problem

According to an aspect of the present disclosure, there is provided an end mill including: a bottom edge formed in a curved convex shape and in an arc shape; and a radial edge provided at a corner and formed in an arc shape. A radius of an arc portion of the radial edge coincides with a radius of an arc portion of a fillet-shaped portion of a shape to be processed. A radius of an arc portion of the bottom edge is equal to or less than a minimum radius of an arc portion of a planar portion adjacent to the fillet-shaped portion.

According to this configuration, the bottom edge is formed in a curved convex shape and in an arc shape, and the radial edge is provided at the corner and is formed in an arc shape. In machining in which the end mill rotates around an axis, the radial edge can form the fillet-shaped portion of the shape to be processed, and the bottom edge can form the planar portion adjacent to the fillet-shaped portion.

Since the radius of the arc portion of the radial edge coincides with the radius of the arc portion of the fillet-shaped portion of the shape to be processed, the fillet-shaped portion is formed in a shape within a target range (range determined based on a target shape) in one pass. In addition, the radius of the arc portion of the bottom edge is equal to or less than the minimum radius of the arc portion of the planar portion of the shape to be processed. When the arc portion of the planar portion has various radii, the planar portion is formed in a target shape in one pass in a portion having the minimum radius.

In the end mill according to the disclosure, in the bottom edge, a diameter of a region, which is occupied by the bottom edge, in a direction perpendicular to an axial direction of the end mill may be set such that the fillet-shaped portion is formed in a shape within a target range in one pass.

According to this configuration, the diameter (bottom edge diameter) of the region, which is occupied by the bottom edge, in the direction perpendicular to the axial direction of the end mill is set such that the fillet-shaped portion is formed in the shape within the target range in one pass.

In the end mill according to the disclosure, the target range of the fillet-shaped portion formed in one pass may be a range determined by an uncut amount in a thickness direction in a portion formed in one pass by cutting by an edge of a boundary between the bottom edge and the radial edge.

According to this configuration, in the fillet-shaped portion formed in one pass, the uncut amount in the thickness direction in the portion formed by cutting by the boundary between the bottom edge and the radial edge has the shape within the target range.

In the end mill according to the disclosure, the target range of the fillet-shaped portion formed in one pass may be a range determined by a position of an uppermost portion of the fillet-shaped portion, which formed in one pass by cutting by the radial edge.

According to this configuration, in the fillet-shaped portion formed in one pass, the shape within the target range is formed at the position of the uppermost portion of the fillet-shaped portion formed by cutting by the radial edge.

In the end mill according to the disclosure, when a corner portion is formed in the fillet-shaped portion in a plan view, the diameter of the region, which is occupied by the bottom edge, in the direction perpendicular to the axial direction of the end mill may be smaller than a diameter of the corner portion.

According to this configuration, the diameter of the region, which is occupied by the bottom edge, in the direction perpendicular to the axial direction of the end mill is smaller than the diameter of the corner portion, so that the corner portion having a target shape can be formed in the fillet-shaped portion.

According to another aspect of the present disclosure, there is provided a method for producing an end mill including a bottom edge formed in a curved convex shape and in an arc shape, and a radial edge provided at a corner and formed in an arc shape, the method including: performing setting such that a radius of an arc portion of the radial edge coincides with a radius of an arc portion of a fillet-shaped portion of a shape to be processed; and performing setting such that a radius of an arc portion of the bottom edge is equal to or less than a minimum radius of an arc portion of a planar portion adjacent to the fillet-shaped portion.

### Advantageous Effects of Invention

According to the present disclosure, the planar portion having a fillet can be processed with high accuracy.

### BRIEF DESCRIPTION OF DRAWINGS

FIG. 1 is a configuration view illustrating a processing device according to one embodiment of the present disclosure.

FIG. 2 is a perspective view illustrating a workpiece.

FIG. 3 is a partially enlarged plan view illustrating the workpiece.

FIG. 4 is a longitudinal cross-sectional view illustrating an end mill and the workpiece according to one embodiment of the present disclosure, and is a view taken along line IV-IV in FIG. 3.

FIG. 5 is a longitudinal cross-sectional view illustrating the end mill and the workpiece according to one embodiment of the present disclosure, and is a view taken along line V-V in FIG. 3.

FIG. 6 is a partially enlarged longitudinal cross-sectional view illustrating the end mill and the workpiece in a portion surrounded by a broken line in FIG. 5.

FIG. 7 is a schematic view illustrating the end mill of the processing device according to one embodiment of the present disclosure.

FIG. 8 is a partially enlarged longitudinal cross-sectional view illustrating the end mill and the workpiece according to one embodiment of the present disclosure.

### DESCRIPTION OF EMBODIMENTS

Hereinafter, an embodiment according to the present disclosure will be described with reference to the drawings.

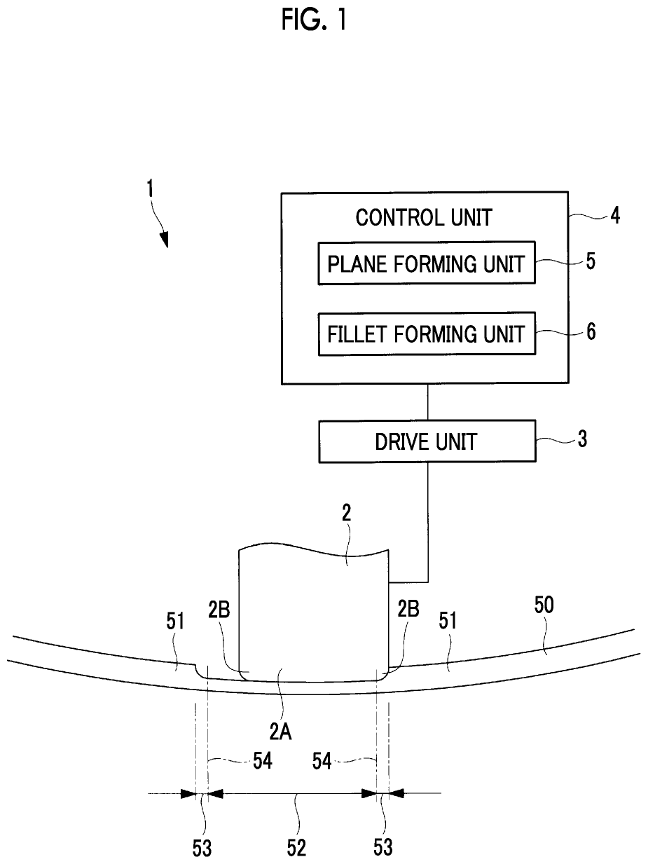

As illustrated in FIG. 1, a processing device 1 according to one embodiment of the present disclosure includes, for example, an end mil 2, a drive unit 3, and a control unit 4. The processing device 1 cuts a workpiece 50 using the end mill 2 to form a predetermined shape in the workpiece 50. The predetermined shape in the present embodiment is, particularly, a concave shape that is formed in the workpiece 50 in a depth direction. The workpiece 50 is, for example, a metallic material such as an aluminum ally or a titanium alloy.

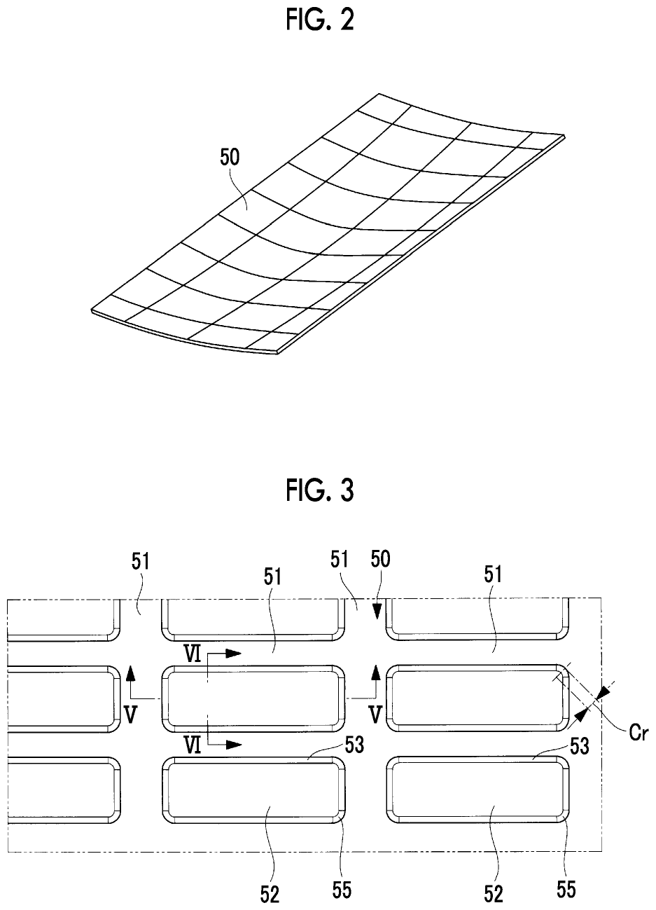

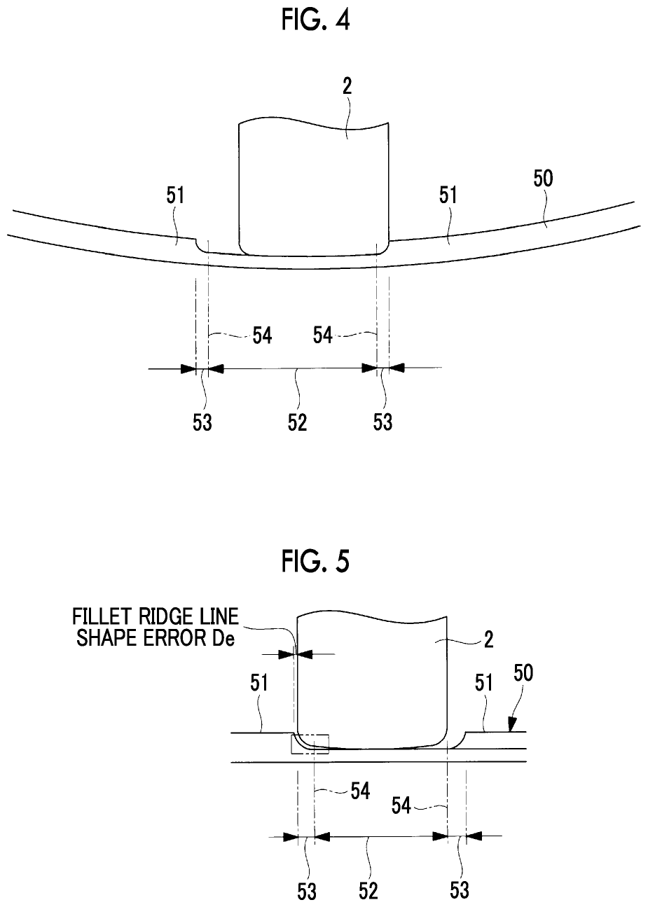

As illustrated in FIGS. 1 to 4, for example, the workpiece 50 is a plate-like component, and in order to secure the strength of the workpiece 50, a rib 51 protruding in a height direction (thickness direction) on one surface side is formed, and a region surrounded by the rib 51 is formed thin. In this case, a region other than the uppermost surface of the rib 51 has a concave shape. The concave shape includes a planar portion 52 formed in a bottom portion of a concave portion. Then, in the concave shape, in order to improve the strength, a connecting portion between the planar portion 52 and the rib 51 is provided not with a non-rounded pin angle but with a fillet-shaped portion 53.

The planar portion 52 may be a flat surface without a curvature, or may have a curved surface shape with a curvature. The fillet-shaped portion 53 has an arc shape having a predetermined radius. One end side of the fillet-shaped portion 53 is formed to be continuous with the planar portion 52, and the other end side of the fillet-shaped portion 53 forms a side wall surface of the rib 51 or is formed to be continuous with the side wall surface of the rib 51.

A boundary 54 between the planar portion 52 and the fillet-shaped portion 53 is a portion in which the curvature of the planar portion 52 (including the case of a flat surface having a curvature of 0 (zero)) and the curvature of the fillet-shaped portion 53 change.

While rotating around an axis, the end mil 2 can move in an axial direction or a feeding direction to cut the workpiece 50. As illustrated in FIG. 7, the end mill 2 includes a bottom edge 2A that is formed in a curved convex shape, and a radial edge 2B that is provided at a corner and is formed in an arc shape.

The bottom edge 2A protrudes such that a portion on the axis of the end mill 2 is located at the lowest position, and is formed in an arc shape having a predetermined radius. The radial edge 2B is provided at an outer peripheral side corner of the bottom edge 2A, and is formed in an arc shape having a predetermined radius. The radius of an arc portion of the bottom edge 2A is larger than the tool diameter (outer diameter) of the end mill 2, and is larger than the radius of an arc portion of a so-called ball end mill.

The drive unit 3 includes a plurality of motors, a switching unit configured to switch the end mill, and the like. A main shaft motor receives electric power to be driven to rotate the end mill 2 around the axis. A motor for movement receives electric power to be driven to move the end mill 2 in the axial direction or a direction perpendicular to the axial direction (feeding direction).

The control unit 4 includes, for example, a plane forming unit 5, a fillet forming unit 6, and the like.

The plane forming unit 5 controls the drive unit 3 such that the bottom edge 2A forms the planar portion 52 of a shape to be processed in the workpiece 50. The fillet forming unit 6 controls the drive unit 3 such that the radial edge 2B forms the fillet-shaped portion 53 in the workpiece 50 in one pass.

The control unit 4 includes, for example, a central processing unit (CPU), a random access memory (RAM), a read only memory (ROM), a computer-readable storage medium, and the like. Then, as one example, a series of processes for realizing various functions are stored in the storage medium or the like in the form of a program, and the CPU reads the program into the RAM or the like to execute information processing and arithmetic processing, so that the various functions are realized. Incidentally, a form in which the program is installed in the ROM or another storage medium in advance, a form in which the program is provided in a state where the program is stored in the computer-readable storage medium, a form in which the program is distributed via wired or wireless communication means, and the like may be applied. The examples of the computer-readable storage medium include magnetic disks, magneto-optical disks, CD-ROMs, DVD-ROMs, semiconductor memories and the like.

The shape to be processed in the workpiece 50 is a concave shape, and the concave shape includes the planar portion 52, and the fillet-shaped portion 53 adjacent to the planar portion 52.

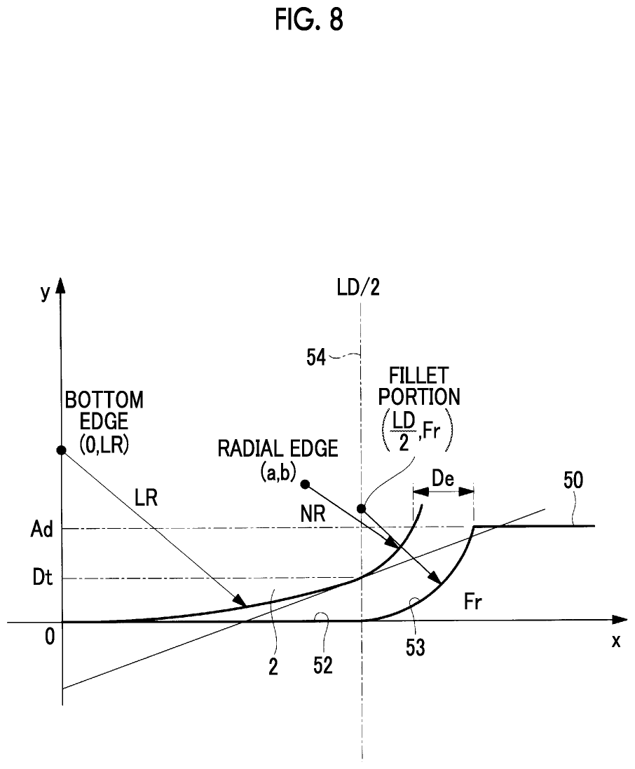

The planar portion 52 may have various curvatures in one workpiece 50, and the curvature radius of an arc portion having a minimum curvature radius among the curvatures is denoted by Mr. In addition, as illustrated in FIG. 8, the curvature radius of an arc portion of the fillet-shaped portion 53 is denoted by Fr, and the minimum processing depth of the concave shape is denoted by Ad. Further, as illustrated in FIG. 3, when a corner portion 55 having a round shape is formed in the concave portion, namely, when an arc-shaped curved surface is formed in the corner portion 55 in a plan view of the concave portion, the curvature radius of the corner portion 55 is denoted by Cr.

A plate thickness tolerance t and a fillet ridge line tolerance e are set as required tolerances in the target shape of a processed product to be formed. The plate thickness tolerance t is a dimension in the height direction, and the fillet ridge line tolerance e is a dimension in a radial direction of the arc shape of a fillet cut plane which is orthogonal to the height direction.

Next, the shape of the end mill 2 according to the present embodiment will be described.

In the end mill 2, the bottom edge (lens portion) 2A is formed in a curved convex shape and in an arc shape, and the radial edge (nose portion) 2B is provided at the corner and is formed in an arc shape. When the end mill 2 performs machining while rotating around the axis, the radial edge 2B can form the fillet-shaped portion 53 of the shape to be processed, and the bottom edge 2A can form the planar portion 52 adjacent to the fillet-shaped portion 53.

According to the end mill 2 of the present embodiment, while a concave shape is formed in the plate-like component, the fillet-shaped portion 53 is formed in a shape within a target range (range determined based on a target shape) in one pass. The curvature radius (nose diameter) of the radial edge 2B of the end mill 2 is denoted by NR, the curvature radius (lens diameter) of the bottom edge 2A is denoted by LR, and the diameter (bottom edge diameter) of a region, which is occupied by the bottom edge 2A, in the direction perpendicular to the axial direction of the end mill 2 is denoted by LD.

The nose curvature radius NR, the lens curvature radius LR, and the bottom edge diameter LD are set, for example, as follows. Accordingly, the end mill 2 can have a maximum diameter, and can efficiently perform cutting.

The nose curvature radius NR is the same as the curvature radius Fr of the arc portion of the fillet-shaped portion 53.

NR=Fr

The lens curvature radius LR is set equal to or less than the curvature radius Mr of the arc portion having the minimum curvature radius in the planar portion 52.

LR≤Mr

In addition, the bottom edge diameter LD may be selected to satisfy the following three conditions. Accordingly, the maximum value of the bottom edge diameter LD of the end mill 2 which is usable can be selected.

The bottom edge diameter LD is set to a value smaller than the diameter (=curvature radius Cr×2) of the corner portion 55.

LD<Cr×2 Condition 1

An uncut amount Dt of the plate thickness is set to, for example, ⅕ of the plate thickness tolerance t or less.

Dt≤t/5 Condition 2

A fillet ridge line shape error De is set to, for example, ⅕ of the fillet ridge line tolerance e or less.

De≤e/5 Condition 3

Incidentally, the maximum values of the uncut amount Dt of the plate thickness and the fillet ridge line shape error De are not limited to ⅕ of the tolerances, and may be other values. Meanwhile, for example, when ½ of the tolerance is set as the maximum value, an error amount for the target shape is too large, and adjustment processing needs to be performed, which is a concern.

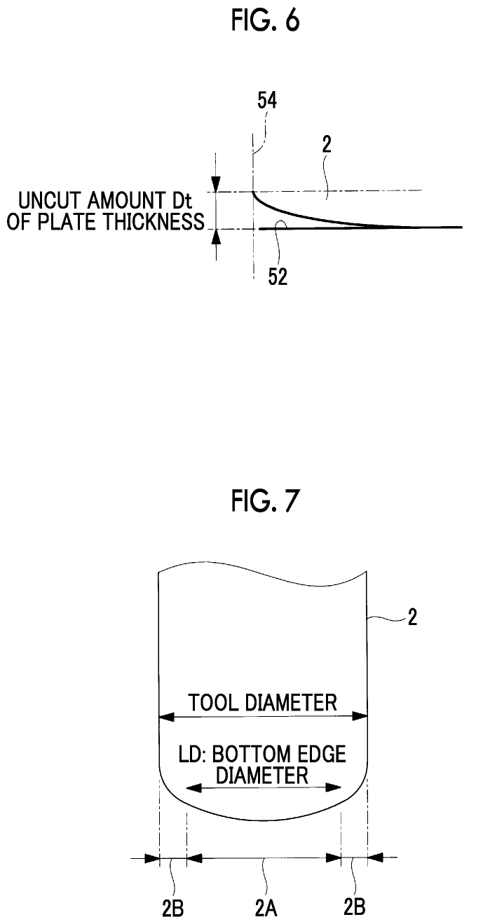

Here, as illustrated in FIG. 6, the uncut amount Dt of the plate thickness is an amount in the thickness direction (height direction) relating to an uncut portion formed by cutting by the edge of the boundary 54 between the fillet-shaped portion 53 and the planar portion 52. In addition, as illustrated in FIG. 5, the fillet ridge line shape error De is the amount of deviation in a radial direction of the arc shape of a fillet cut plane in an uppermost portion of the fillet-shaped portion 53 formed by cutting by the radial edge 2B.

As will be described later, the uncut amount Dt of the plate thickness is a value determined by a function of the bottom edge diameter LD and the lens curvature radius LR.

Dt=f(LD,LR)

The fillet ridge line shape error De is a value determined by a function of the bottom edge diameter LD, the lens curvature radius LR, the nose curvature radius NR, and the minimum processing depth Ad of the concave shape.

De=g(LD,LR,NR,Ad)

Therefore, once the lens curvature radius LR and the nose curvature radius NR are determined, the maximum value of the bottom edge diameter LD which is usable can be selected.

The uncut amount Dt of the plate thickness and the fillet ridge line shape error De have maximum values when the planar portion 52 having a target shape has no curvature and is a flat surface.

The cross-sectional curve of the bottom edge 2A is expressed by the following equation.

[Equation 1]

x²+(y−LR)²=LR² (1)

The cross-sectional curve of the radial edge 2B is expressed by the following equation.

[Equation 2]

(x−a)²+(y−b)²=NR² (2)

The cross-sectional curve of the fillet-shaped portion 53 in the workpiece is expressed by the following equation.

$$\begin{matrix}[ Equation 3 ] & \\ {( x - \frac{L D}{2} )}^{2} + {( y - Fr )}^{2} = F {r}^{2} & ( 3 )\end{matrix}$$

Since (x, y)=(LD/2, Dt) from Equation (1) of the bottom edge 2A, the uncut amount Dt of the plate thickness is obtained as follows.

$$\begin{matrix}[ Equation 4 ] & \\ Dt = f ( LD , LR ) = L R - \sqrt{L {R}^{2} - \frac{L {D}^{2}}{4}} & \end{matrix}$$

The uncut amount Dt of the plate thickness is a value determined by a function of the bottom edge diameter LD and the lens curvature radius LR. Therefore, a function f relating to the bottom edge diameter LD and the lens curvature radius LR when the uncut amount Dt of the plate thickness is a predetermined value Dt1 is determined.

In order to calculate the fillet ridge line shape error De, it is required to obtain the center (a, b) of Equation (2) of the radial edge 2B. In addition, Equation (1) of the bottom edge 2A and Equation (2) of the radial edge 2B are required to have the same tangent at (x, y)=(LD/2, Dt).

The following is obtained from the tangent equation of Equation (1).

$$[ Equation 5 ]$$

$$\frac{L D}{2} x + ( Dt - LR ) ( y - L R ) = L {R}^{2}$$

The following is obtained from the tangent equation of Equation (2)

$$[ Equation 6 ]$$

$$( \frac{L D}{2} - a ) ( x - a ) + ( Dt - b ) ( v - b ) = N {R}^{2}$$

From the above two equations, (a, b) is as follows.

$$[ Equation 7 ]$$

$$b = LR + \frac{2 ( Dt - LR )}{LD} a \\ [ Equation 8 ]$$

$$\text{?} = \frac{\begin{matrix}( \text{?} - \text{?} + \text{?} + \text{?} ) - \\ \sqrt{( \begin{matrix}4 \text{?} - 4 ( 2 LD + \frac{\text{?} - \text{?}}{LD} ) \\ ( \text{?} LDL \text{?} )\end{matrix} )}\end{matrix} }{( 2 ( 2 LD + \frac{\text{?} - \text{?}}{LD} ) )}$$

$$\text{?} \text{indicates text missing or illegible when filed}$$

The fillet ridge line shape error De is a difference in x-coordinate when y=Ad between Equation (2) of the radial edge 2B and Equation (3) of the fillet-shaped portion 53 in the workpiece. Therefore, when (x, y)=(x_{N}, Ad), x_{N} is expressed as follows from Equation (2).

x_{N}=a+\sqrt{NR²−(Ad−b)²} [Equation 9]

In addition, when (x, y)=(x_{F}, Ad), x_{F} is expressed as follows from Equation (3).

$$[ Equation 10 ]$$

$${x}_{F} = \frac{LD}{2} + \sqrt{{NR}^{2} - {( Ad - NR )}^{2}}$$

The fillet ridge line shape error De is as follows from the above equations.

De=g(LD,IS,NR,Ad)=x_{F}−x_{N} [Equation 11]

Namely, the fillet ridge line shape error De is a value determined by a function of the bottom edge diameter LD, the lens curvature radius LR, the nose curvature radius NR, and the minimum processing depth Ad of the concave shape. Therefore, a function g relating to the bottom edge diameter LD and the lens curvature radius LR when the fillet ridge line shape error De is a predetermined value Del, the minimum processing depth Ad of the concave shape is a predetermined value Ad1, and the nose curvature radius NR is a predetermined value NR1 is determined.

The bottom edge diameter LD is set to a value smaller than the diameter (=curvature radius Cr×2) of the corner portion 55.

The range of the bottom edge diameter LD in which the uncut amount Dt of the plate thickness is the predetermined value Dt1 or less is determined for each lens curvature radius LR by the function f. The range of the bottom edge diameter LD in which the fillet ridge line shape error De is the predetermined value Del or less is determined for each lens curvature radius LR and each nose curvature radius NR by the function g.

Therefore, when a maximum bottom edge diameter LDmax is selected for a certain lens curvature radius LR such that uncut amount Dt of the plate thickness is the predetermined value Dt1 or less and the fillet ridge line shape error De is the predetermined value Del or less, cutting can be efficiently performed.

In both the function f relating to the uncut amount Dt of the plate thickness and the function g relating to the fillet ridge line shape error De, the larger the lens curvature radius LR is, the larger the selectable maximum value of the bottom edge diameter LD is.

In addition, according to the function g relating to the fillet ridge line shape error De, the larger the nose curvature radius NR is, the smaller the selectable maximum value of the bottom edge diameter LD tends to be.

Further, according to the function g relating to the fillet ridge line shape error De, the deeper the minimum processing depth Ad of the concave shape is, the larger the selectable maximum value of the bottom edge diameter LD tends to be.

From the above discussion, when the curvature radius Fr of the arc portion of the fillet-shaped portion 53 is small and the minimum processing depth Ad of the concave shape is deep, the uncut amount Dt of the plate thickness is limited. Namely, the maximum value of the bottom edge diameter LD is selected such that the uncut amount Dt of the plate thickness is a predetermined value (for example, a value based on the plate thickness tolerance t) or less in the function f relating to the uncut amount Dt of the plate thickness, and the lens curvature radius LR and the nose curvature radius NR are determined.

On the other hand, when the curvature radius Fr of the arc portion of the fillet-shaped portion 53 is large and the minimum processing depth Ad of the concave shape is shallow, both the function f relating to the uncut amount Dt of the plate thickness and the function g relating to the fillet ridge line shape error De are considered. Namely, the maximum value of the bottom edge diameter LD is selected such that the uncut amount Dt of the plate thickness is a predetermined value (for example, a value based on the plate thickness tolerance t) or less in the function f relating to the uncut amount Dt of the plate thickness, and the maximum value of the bottom edge diameter LD is selected such that the fillet ridge line shape error De is a predetermined value (for example, a value based on the fillet ridge line tolerance) in the function g relating to the fillet ridge line shape error De, and the lens curvature radius LR and the nose curvature radius NR are determined.

As described above, according to the present embodiment, it is possible to obtain a tool with the bottom edge diameter LD having a maximum value, which can efficiently process the planar portion (compound curved surface) 52 of any curvature radius having a fillet with high accuracy. Then, the planar portion 52 having a fillet can be processed with high accuracy by the tool.

### REFERENCE SIGNS LIST

1: Processing device
2: End mill
2A: Bottom edge
2B: Radial edge
3: Drive unit
4: Control unit
5: Plane forming unit
6: Fillet forming unit
50: Workpiece
51: Rib
52: Planar portion
53: Fillet-shaped portion
54: Boundary
55: Corner portion

1. An end mill comprising:
a bottom edge formed in a curved convex shape and in an arc shape; and
a radial edge provided at a corner and formed in an arc shape,
wherein a radius of an arc portion of the radial edge coincides with a radius of an arc portion of a fillet-shaped portion of a shape to be processed, and
a radius of an arc portion of the bottom edge is equal to or less than a minimum radius of an arc portion of a planar portion adjacent to the fillet-shaped portion.

2. The end mill according to claim 1,
wherein in the bottom edge, a diameter of a region, which is occupied by the bottom edge, in a direction perpendicular to an axial direction of the end mill is set such that the fillet-shaped portion is formed in a shape within a target range in one pass.

3. The end mill according to claim 2,
wherein the target range of the fillet-shaped portion formed in one pass is a range determined by an uncut amount in a thickness direction in a portion formed in one pass by cutting by an edge of a boundary between the bottom edge and the radial edge.

4. The end mill according to claim 2,
wherein the target range of the fillet-shaped portion formed in one pass is a range determined by a position of an uppermost portion of the fillet-shaped portion, which formed in one pass by cutting by the radial edge.

5. The end mill according to claim 2,
wherein when a corner portion is formed in the fillet-shaped portion in a plan view, the diameter of the region, which is occupied by the bottom edge, in the direction perpendicular to the axial direction of the end mill is smaller than a diameter of the corner portion.

6. A method for producing an end mill including a bottom edge formed in a curved convex shape and in an arc shape, and a radial edge provided at a corner and formed in an arc shape, the method comprising:
performing setting such that a radius of an arc portion of the radial edge coincides with a radius of an arc portion of a fillet-shaped portion of a shape to be processed; and
performing setting such that a radius of an arc portion of the bottom edge is equal to or less than a minimum radius of an arc portion of a planar portion adjacent to the fillet-shaped portion.
